(19) United States
(12) Patent Application Publication
(10) Pub. No.: US 2005/0182687 A1
(43) Pub. Date: Aug. 18, 2005

(54) System and method of providing multi-vendor retail goods and services

(76) Inventor: Jack Godfrey JR., Arlington, TX (US)

Correspondence Address: FISH & RICHARDSON P.C., 1717 MAIN STREET, SUITE 500, DALLAS, TX, 75201, US

(21) Appl. No.: 11/056,482

(22) Filed: Feb. 11, 2005

Related U.S. Application Data
(60) Provisional application No. 60/543,871, filed on Feb. 12, 2004.

(51) Int. Cl. G06F 17/60

(52) U.S. Cl. 705/26

(57) ABSTRACT

A system and method of providing multi-vendor goods and services to consumers is provided. According to the system and method, the goods and services of multiple vendors or suppliers, including online or virtual ones, are available to consumers and potential consumers in a single location, equally accessible via vehicle, on foot and/or virtual access.

### RELATED APPLICATION

This claims priority under 35 USC §119(e) to U.S. Patent Application Ser. No. 60/543,871, filed on Feb. 12, 2004, the entire contents of which are hereby incorporated by reference.

### TECHNICAL FIELD

This invention relates to the provision of goods and services, and more particularly to a system and method of providing multi-vendor goods and services to consumers.

### BACKGROUND

A fundamental and persistent issue in business is the effective and efficient provision of goods and services to consumers and potential consumers. It is known for the provider of goods and services to operate their businesses out of physical locations (versus online, for example). It is also known that the actual location of a business offering goods and services can be critical to the success of such business. More than a few businesses have failed due to operations in a poor location. Locations for conducting business can be “poor” for a number of reasons, including most notably, lack of reasonable and convenient access by consumers and potential consumers.

In an effort to increase the convenience of consumers and potential consumers, businesses have for many years offered various enhancements for accessing their businesses, such as drive-through windows, home delivery, online sites, and the like. The invention of the drive-through window naturally closely followed the rise in popularity and importance of the automobile in the early twentieth century. Although many businesses (e.g., fast food operations) still use drive-up windows to offer ease of access to their customers, the drive-up window has not changed much since its invention.

Businesses have also attempted certain co-branding and co-location of related goods and services in an attempt to provide convenience and ease of access to consumers and potential consumers. For example, it is not uncommon to see pizza franchises located next to or very near a video rental store, the theory being that as consumers stop to pick up dinner, they will also pick up a video, or vice versa. Other prior art attempts include the teaming of a gas station with a fast food operation in the same building or location, or a bank branch in a grocery store. Although these prior art attempts to provide convenience and ease of access to consumer and potential consumers have been met with some success, there exists a number of drawbacks associated with them. For example, most prior art co-location scenarios are limited to, at most, two different sources for goods and/or services. Additionally, even where multiple sources are co-located, there remain access difficulties with transacting business with one or more of these sources. Finally, some co-location schemes actually detract from use of the individual sources within the scheme in some circumstances. For example, a consumer only seeking fast food might reasonably avoid a fast food restaurant co-located with a gas station since the increased traffic in and around a typical gas station will reduce the accessibility and speed of the desired business transaction.

A related prior art attempt to enhance convenience and ease of access for consumers and potential consumers is the development of the shopping mall. Malls are collections of establishments generally located in a single physical location. Malls come in a variety of sizes and types. For example, “strip” malls typically include a relatively small number of merchants co-located in a manner that has separate, generally external, entrances for each merchant along the length of a building, a hallway, or the like. On the opposite end of the spectrum, large urban malls often include hundreds of merchants co-located within a large building or grouping of buildings. There are a number of downsides associated with traditional malls. Such disadvantages include parking problems, the relatively large number of merchants located in a single location, security and the like.

In the more recent past, attempts to offer goods and services via mass communication options, such as global communication networks (e.g., the Internet) have flourished. Today it is difficult to imagine a provider of goods and/or services that does not have some ability to provide its goods and/or services to consumers and potential consumers via the Internet. The associated benefits are considerable. Such virtual access avoids the traditional concerns regarding access to a physical location, such as traffic, parking, security, limited store hours and weather. Additionally, virtual providers of goods and/or services may offer a broader array of goods/services since actual inventories are not necessarily needed. However, other important disadvantages exist with respect to online marketplaces. For example, goods must be moved from point A (e.g., the online retailer or a distribution center or the like) to point B (the consumer) typically via a third party (e.g., UPS), adding costs to the goods and logistical impediments to the transaction. For example, it is estimated that as much as 40% of online transactions produce complaints by the consumers based upon transit or delivery of the product purchased. Such complaints range from increased costs of delivery (whether directly encountered or assumed as part of the price of the goods) and slowness of delivery (expedited delivery can often add significant costs to online delivery) to inconvenience of delivery (consumers must assure that they are in a physical location (e.g., at home) to receive certain items via shipment). Additionally, theft and vandalism can be commonplace with deliveries “left” without a signature or proper security measures.

Moreover, product returns, exchanges and the like are complicated in a virtual relationship. Consumers are understandably reluctant to return or exchange items due to the reverse logistics of the above-identified typical third party shipping/delivery process. Consumers therefore often keep useless, damaged or unwanted items to avoid making a return/exchange, significantly reducing or eliminating any good will the source of goods has built up with the consumer. It is noted that the same or similar disadvantages also exist with respect to telephone and catalog orders of goods/services.

Some providers of goods/services have attempted to remedy some of the above-identified problems associated with virtual marketplaces by allowing online consumers to view goods/services and/or make returns/exchanges at related physical locations (e.g., bricks and mortar locations of, or associated with, the provider). However, an ever-increasing number of online providers do not have physical locations. Additionally, for the ones who still do there are often differences in inventory and/or pricing that further frustrates any potential advantages gained by this effort.

As outlined above, there remains a need for the provision of goods and services from a variety of different sources (including, without limitation, online or virtual sources) to consumers and potential consumers in a single location and in a manner that provides enhanced convenience of access and use by the consumers and potential consumers. Such access would accommodate vehicle, on foot and/or virtual access.

### SUMMARY

The present invention relates to the provision of multi-vendor goods and services to consumers and potential consumers. More specifically, the present invention method provides the goods and services of multiple vendors or suppliers, including, without limitation, online or virtual providers, to consumers and potential consumers in a single physical location, equally accessible via vehicle, on foot and/or virtual access. The system of the present invention provides the integration of communications and data to facilitate the combined provision of goods and services from multiple sources, including, without limitation, virtual sources, in a single, physical location.

In one embodiment of the method of the present invention, a facility is provided that is adapted to provide goods and/or services from multiple vendors and suppliers to consumers and potential consumers in a single physical location. The facility includes a variety of both interior and exterior entry/exit points associated therewith, and also includes virtual access points for facilitating information exchange and transactions between consumers and virtual sources of goods and/or services associated with the facility. Such virtual access points comprise computers tied with a centralized computer network that handles and coordinates data and communications between the various sources of goods and/or services, the consumers, and others associated with the facility (e.g., vendors/suppliers).

In one embodiment interior entrances of the facility are associated with a drive-up and/or drive-through feature that allows consumers and potential consumers to navigate vehicles through and transact business with one or more of the sources of goods and/or services. Transacting business includes, without limitation, the order, purchase, delivery and pick-up of goods and/or services.

In this embodiment, exterior entry points for the multiple sources of goods and/or services are primarily associated with foot traffic of consumers and potential consumers, although they can also be used by vehicular traffic, if desired. For example, in this embodiment the multiple sources would be co-located in the facility having an interior courtyard area accessible by vehicles via one or more access points within the building. The various sources of goods and services are optionally separately housed within spaces the building or share such spaces, as desired. In this embodiment, each source of goods and/or services has a separate entry point from the exterior of the building associated with it, and an entry point from the interior courtyard. In other embodiments, sources of goods and/or services share entry points and access points, if desired.

In this embodiment, the interior courtyard of the building further includes one or more areas (e.g., an island or a counter) via which operators of vehicles, such as automobiles can transact business with the various sources of goods/services in the building. As an example, the various sources of goods/services place personnel at the island or counter so that business is transacted by those in motor vehicles without the need for the operator to leave his/her vehicle. Alternatively, parking spaces within the interior courtyard allow consumers to park and enter the spaces associated with the multiple sources via foot. Optionally, business can be transacted with either the vendors physically present in the facility or the virtual vendors via one or more computer terminals linked to the centralized computer network (which is also linked to global computer networks, such as the Internet).

The exchange of information and/or engaging in a transaction between consumers and one or more of the multiple vendors (virtual or physically present in the facility) can occur in a number of ways. As just one example, a consumer may drive a vehicle into the facility via one of the entry access points. The consumer can then drive up to a counter or island and, depending upon the configuration of the facility, either transact business with a vendor via a person stationed at the counter and/or via a computer terminal present at the counter and adapted for use by a person in a vehicle. Alternatively, the consumer could park the vehicle and travel on foot to one of the counters and/or enter one of the interior spaces associated with one or more of the vendors physically located in the facility. Of course, the consumer on foot could also transact business with any of the multiple vendors physically located in or virtually represented by the facility through a computer terminal associated with the facility.

Consumers interacting with the multiple vendors associated with the facility can transact all of their business at the facility, or may pre-order goods, arrange for delivery of items, schedule pick-up times, etc., via any communication device (e.g., personal digital assistant, computer, telephone) capable of communicating with the centralized computer network (e.g., via the Internet).

### DESCRIPTION OF DRAWINGS

FIG. 1 is an illustration of a floor plan for a facility in accordance with one embodiment of the present invention and method;

FIG. 2 is an illustration of a floor plan for a facility in accordance with another embodiment of the present invention and method;

FIG. 3 is an illustration of a floor plan for a facility in accordance with yet another embodiment of the present invention and method; and

FIG. 4 is a flowchart outlining the steps associated with an embodiment of the method of the present invention.

Like reference symbols in the various drawings indicate like elements.

### DETAILED DESCRIPTION

The present invention relates to the provision of multi-vendor goods and services to consumers and potential consumers. More specifically, the present invention method provides the goods and services of multiple vendors or suppliers, including, without limitation, online or virtual vendors or suppliers, to consumers and potential consumers in a single location, equally accessible via vehicle, on foot and/or virtual access. For purposes of the present invention: the term “vehicle” shall encompass vehicles of all kinds and designs, including, without limitation, automobiles, motorcycles, bicycles, buses and the like; the term “multiple providers of goods and/or services” shall encompass all entities capable of providing goods and/or services to others, including, without limitation, vendors, suppliers, manufacturers, OEMs, resellers, value-added resellers, distributors, and the like; and the term “goods and/or services” shall encompass all goods (durable or otherwise) and services capable of being designed, manufactured, produced or provided by one party to another party.

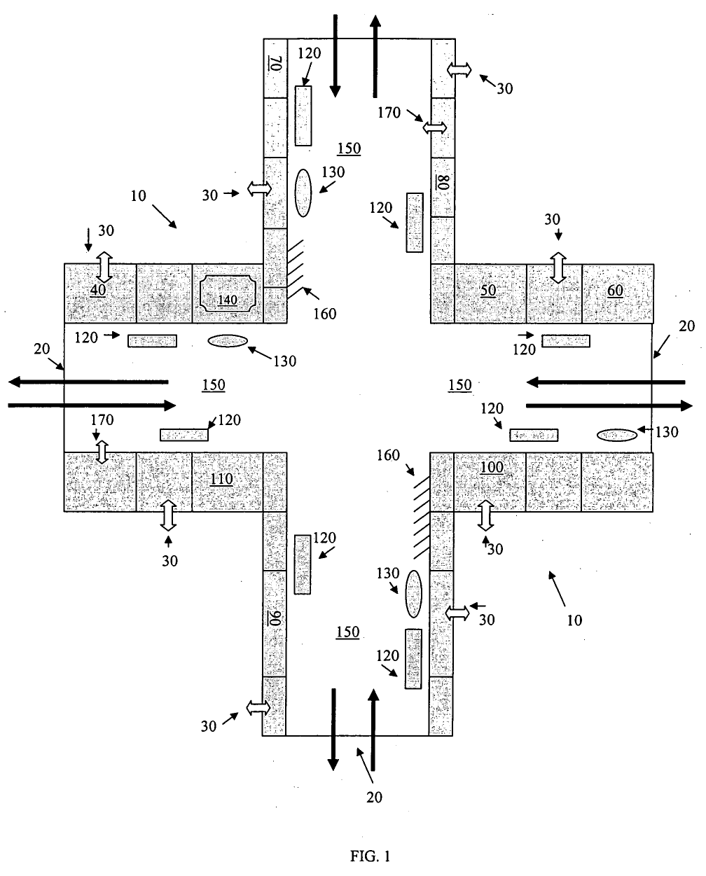

FIG. 1 is an illustration of a representative floor plan for a facility in accordance with one embodiment of the present invention method. The facility 10 includes one or more vehicle access points 20 along its exterior and one or more external access points 30 to accommodate foot traffic of consumers. Located within the facility 10 are multiple units 40, 50, 60, 70, 80, 90, 100 and 110 capable of providing a physical presence within the facility 10 for multiple providers of goods and/or services. Also located within the facility 10 of this embodiment are at least one counter 120 and at least one terminal 130. Preferably, multiple counters 120 and terminals 130 are associated with the facility 10, but any number may be used, as desired. Additionally, although the counter 120 and the terminal 130 are described as separate entities in this description, it is noted that the counter 120 and terminal 130 could be co-located, within the same structure, if desired.

The at least one counter 120 is adapted to allow personnel associated with the facility 10 (either employees of the facility 10 or personnel associated with one or more of the providers of goods and/or services) to interact and transact business with consumers in their vehicles or on foot. One example of such a counter would be a kiosk. The at least one counter 120 and the at least one terminal 130 are preferably adapted for use by consumers either in their vehicles or on foot.

A centralized computer network 140 is associated with the facility 10 and coordinates all communications between consumers and the multiple providers of goods. and/or services. Preferably, the centralized computer network 140 is not only linked to all of the providers of goods and/or services physically present within the facility 10, but also with global computer and communication networks, such as the Internet, to allow virtual providers of goods and/or services to also have a “presence” within the facility 10. Additionally, such a link with communications systems outside the facility 10 allows consumers and potential consumers to order, check status, purchase, arrange for delivery or pick-up with all of the providers of goods and/or services associated with the facility 10 via a computer, a personal digital assistant, a telephone or other communications device without the need to physically visit the facility 10. Via the at least one terminal 130, a consumer can interact and transact business with any of the multiple providers of goods and/or services physically located in the facility 10 or virtually associated with the facility 10.

The centralized computer network 140 is preferably networked or otherwise linked with the at least one terminal 130, the at least one counter 120 and global computer and communications systems, like the Internet, such that the multiple providers of goods and/or services are linked with each other and the outside world. This allows the multiple providers of goods and/or services to share data, information, maintain web presences, take orders, share inventory (either physically associated with the facility 10 or offsite), communicate with consumers and potential consumers and otherwise conduct business. As used herein, the term “network” refers to any interconnection between two or more devices over which information is capable of being transferred.

An additional feature of the method and system of the present invention is the use of the centralized computer network 140 to coordinate not only business aspects (e.g., shared inventories, shared labor; shared deliveries, etc.) of the multiple providers of goods and/or services, but also to facilitate joint marketing and promotional activities amongst the multiple providers of goods and/or services. Such efforts include, without limitation, cooperative reward programs, advertising, co- and multi-branding opportunities, and the like. For example, the multiple providers of goods and/or services associated with the facility 10 (including virtual providers) could utilize the centralized computer network 140 to share marketing information gathered from consumers interacting and transacting business with the multiple providers of goods and/or services. Additionally, joint promotional efforts (e.g., games, games of chance, sweepstakes, contests, etc.) are coordinated to mutually benefit the multiple providers of goods and/or services.

The at least one counter 120 preferably includes one or more computers which link it to the centralized computer network 140 such that through the at least one counter 120, a consumer (with or without assistance from personnel associated with the facility 10) may interact and/or transact business with one or more of the multiple providers of goods and/or services. The at least one terminal 130 preferably includes features such as high resolution monitors, touch- based interface, speech recognition and the like to facilitate a consumer interacting and/or transacting business with one or more of the multiple providers of goods and/or services via the at least one terminal 130.

This embodiment of the facility 10 also includes multiple lanes 150 through which vehicular traffic accesses the facility via one or more of the vehicle access points 20. At least one parking area 160 associated with the facility 10 allows consumers to park their vehicles and either interact and/or transact business with a provider of goods and/or services by entering a unit associated with that provider (units 40, 50, 60, 70, 80, 90, 100 and 110, for example) or walk up to the at least one counter 120 and/or the at least one terminal 130 to accomplish same.

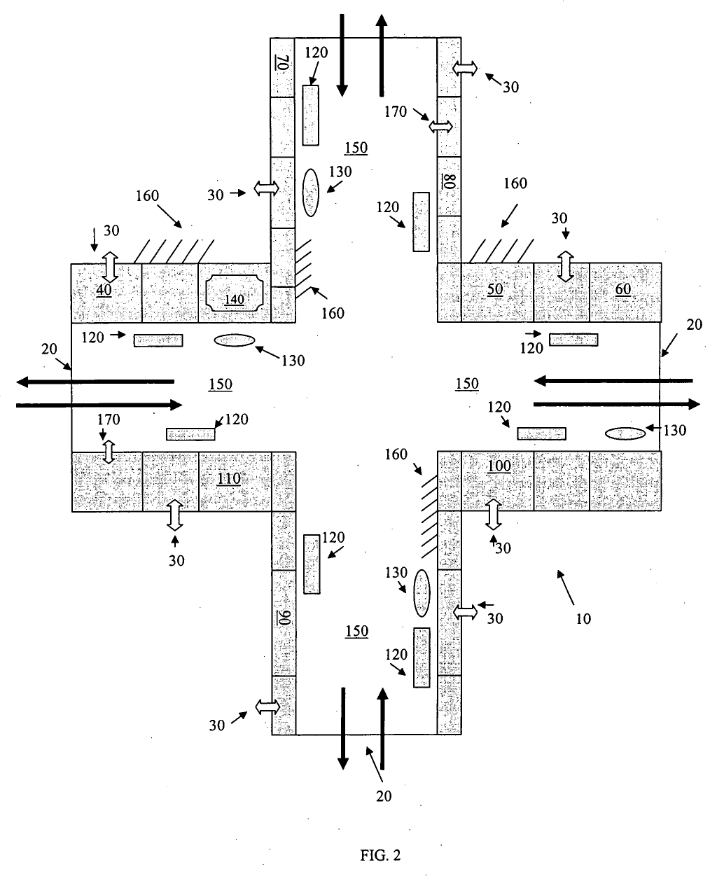

In FIG. 1, the parking spaces 160 are illustrated as being within the facility 10. As illustrated in FIG. 2, the parking spaces 160 could also be located outside of the facility 10 in addition to, or in lieu of, the parking spaces 160 located within the facility.

Referring to FIGS. 1 and 2, regardless of the location of the parking spaces 160, consumers can access the facility 10 via one or more of the external access points 30, if desired, to interact and/or transact business with the multiple providers of goods and/or services.

In use, a consumer wishing to interact with and/or transact business with one or more of the providers of goods and/or services can do so in one of a number of ways. First, the consumer may physically visit the facility 10. Such a visit can be accomplished within a vehicle or by foot. Using a vehicle, the consumer may choose to park in an exterior parking area 160 and access the facility (or any of the individual providers of goods and/or services) through one of the external access points 30. Alternatively, the consumer may operate the vehicle to enter the facility 10 via one of the lanes 150 and either interact and/or transact business with a provider via a counter 120 or by parking in an interior parking area 160 and accessing one or more of units (for example, unit 40) of the providers of goods and/or services on foot via internal access points 170, or, alternatively, by utilizing one of the terminals 130 associated with the facility 10.

If the consumer wishes to interact and/or transact business with one or more of the multiple providers of goods and/or services without making a visit to the facility 10, the consumer may access the facility 10 through a global communications network, such as the Internet, via the centralized computer network 140. Utilizing this method of access, the consumer may view, order, purchase, arrange to pick-up, request delivery, and otherwise communicate with the multiple providers of goods and/or services associated with the facility 10.

Although the illustration provided in FIGS. 1 and 2 are a single story facility 10, it is noted that there can be any number of stories (with ramps as required to direct vehicle traffic to upper floors and/or limited to foot traffic above the ground floor), as desired, in the facility 10. Additionally, the floor plan illustrated is representative only and is a simplified version of the embodiment. In an actual floor plan, there could be hundreds of units (for example, unit 40) in which providers of goods and/or services could have a presence in the facility. Economies of scale would dictate that additional advantages would be realized as the number of units (for example, 40) grow, at least to some point.

It is noted that any providers of goods and/or services could occupy the unit (for example, unit 40) of the facility 10. Although not shown in FIG. 1, the facility 10 would preferably include stairs, elevators and the like to provide foot traffic access to vendors located in the second and higher stories of the facility 10.

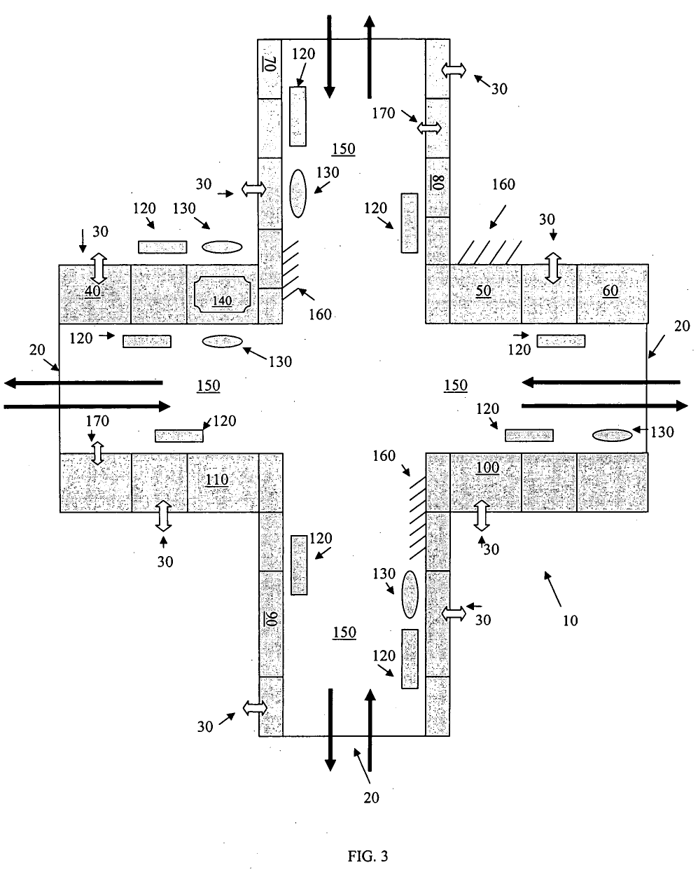

As illustrated in FIG. 3, the location of the at least one counter 120 (such as a kiosk) and the at least one terminal 130 can be external to the facility 10. In this embodiment, the at least on counter 120 and the at least one terminal 130 are capable of being accessed by consumers without the need to physically enter the facility 10. As with the above-described embodiments having the at least one counter 120 and the at least one terminal 130 with the interior of the facility 10, the design of the at least one counter 120 and the at least one terminal 130 facilitates use of same by consumers on foot and/or in vehicles. Regardless of the embodiment, the at least one counter 120 and/or the at least one terminal 130 preferably include means for sensing and interacting that allows consumers with traditional electronic identification technologies (e.g., RFID tags, such as tolltags or electronic passkeys) to utilize same in interacting and/or transacting business with the multiple providers of goods and/or services. For example, a consumer with a RFID-based identification tag (e.g., toll tag such as EZ Pass™) could use same to provide information to the at least one counter 120 and/or the at least one terminal 130 to facilitate a transaction (e.g., have the price of the goods purchased from the multiple providers of goods and/or services added to a credit or debit card associated with their RFID-based tag.

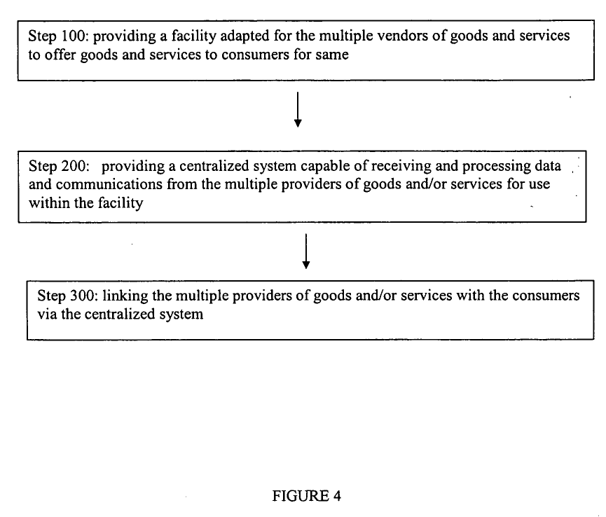

As outlined in FIG. 4, one embodiment of the method of the present invention comprises the steps of: Step 100, providing a facility adapted for multiple vendors of goods and services to offer goods and services to a consumer. The facility preferably includes various access points for processing vehicular traffic, foot traffic and virtual traffic. In Step 200, a centralized computer system is provided in association with the facility to receive and process data and communications from the multiple providers of goods and/or services and to link the multiple providers with consumers and the outside world via connection with a global communications network, such as the Internet; and Step 300: linking the multiple providers of goods and/or services with the consumers via the centralized system. Preferably, there are kiosks, counters, terminals and the like available both inside and external to the facility to facilitate interaction and/or the transaction of business between consumers and the multiple providers of goods and/or services.

A number of embodiments of the invention have been described. Nevertheless, it will be understood that various modifications may be made without departing from the spirit and scope of the invention. For example, multi-vendor centers can include any number of floors or levels and/or may or may not include both interior and exterior access points for the various vendors, if desired. Accordingly, other embodiments are within the scope of the following claim.

1. A method for providing goods and services from multiple providers to consumers in a single physical location, said method comprising the steps of:
providing a facility adapted for the multiple vendors of goods and services to offer goods and services to the consumers, said facility including access points for processing vehicular traffic, foot traffic and virtual traffic; and
providing a centralized system capable of receiving and processing data and communications from the multiple providers of goods and/or services for use within the facility;
said centralized system further capable of facilitating communications related to a transaction between consumers and the multiple vendors.

2. The method of claim 1, wherein the method further includes the step of linking the multiple vendors of goods and services with the outside world.

3. The method of claim 2, wherein the step of linking includes connecting the centralized system to a global communications network.

4. The method of claim 3, wherein the global communications network is the Internet.

5. The method of claim 1, wherein the access points for vehicular traffic and foot traffic are exterior entry/exit points associated with the facility.

6. The method of claim 1, wherein the access points for vehicular traffic and foot traffic are interior entry/exit points associated with the facility.

7. The method of claim 5, wherein the exterior entry points are specific for each of the multiple providers of goods and/or services.

8. The method of claim 5, wherein the exterior entry points are shared by the multiple provider of goods and/or services.

9. A system for multiple providers of goods and services to provide same to consumers in a single physical location, said system comprising:
a facility adapted for the multiple providers of goods and services to offer goods and services to the consumers; and
a centralized system capable of receiving and processing data and communications from the multiple providers of goods and/or services for use within the facility.

10. The system of claim 9, wherein the facility includes one or more access points for processing vehicular traffic, foot traffic and virtual traffic.

11. The system of claim 10, wherein the one or more access points includes at least one physical access point to enter and exit the facility via foot.

12. The system of claim 10, wherein the one or more access points includes at least one physical access point to enter and exit the facility via a vehicle.

13. The system of claim 10, wherein the one ore more access points includes at least one virtual access point for the consumers to interact with and transact business with the multiple providers of goods and services via a communication device.

14. The system of claim 9, wherein the centralized system is connected to a global communications network to link the multiple vendors of goods and services with the outside world.

15. The system of claim 11, wherein the global communications network is the Internet.

16. The system of claim 9, wherein the facility includes at least one counter via which the consumer can interact and transact business with the multiple providers of goods and services.

17. The system of claim 9, wherein the at least one counter is a kiosk.

18. The system of claim 9, wherein the centralized system includes at least one terminal linked thereto through which the consumers can interact and transact business with the multiple providers of goods and services.

19. The system of claim 18, wherein the at least one terminal is a computer.

20. The system of claim 18, wherein the at least one terminal is adapted for use by the consumer in a vehicle and on foot.
